(19) United States
(12) Patent Application Publication
(10) Pub. No.: US 2025/0185840 A1
(43) Pub. Date: Jun. 12, 2025

(54) BEVERAGE MAKER WITH HELICALLY DISPENSED BREWING WATER

(71) Applicant: Chih-Te LIN, Taoyuan City (TW)

(72) Inventor: Chih-Te LIN, Taoyuan City (TW)

(21) Appl. No.: 18/939,980

(22) Filed: Nov. 7, 2024

(30) Foreign Application Priority Data
Dec. 7, 2023 (TW) 112213384

(51) Int. Cl. A47J 31/44

(52) U.S. Cl. CPC A47J 31/4475

(57) ABSTRACT

A beverage maker with helically dispensed brewing water includes a reciprocating mechanism provided on a movable support, and a water dispensing pipe extended through an elongated guide slot on the movable support. The movable support is rotatable about a rotation axis relative to a fixed support and brings the reciprocating mechanism and the water dispensing pipe to revolve synchronously with the movable support. Meanwhile, the reciprocating mechanism brings the water dispensing pipe to move linearly in along the elongated guide slot. Therefore, the water dispensing pipe not only revolves about the rotation axis but also moves linearly, such that water dispensed from the water dispensing pipe is in the form of a conical helical flow, allowing the brewing water to uniformly contact with a brewing substance and producing a beverage with rich flavor. Therefore, the beverage maker is able to achieve the same effect as a hand pour brewed beverage.

### FIELD OF THE INVENTION

The present invention relates to a beverage maker for dispensing water to brew a brewing substance, and more particularly, to a beverage maker that dispenses water helically on a brewing substance.

### BACKGROUND OF THE INVENTION

Following constant changes in food culture, there is a variety of ingredients available for cooking. There are also many changes in the way of preparing the ingredients, even the liquid beverages for drinking. In view of the variety of beverages and for the purpose of enjoying drinking beverages conveniently, beverages can be supplied in the market in a lot of ways. Presently, coffee is one of the most popular drinks among people. In addition to buying their favorite coffee beverages, coffee lovers would even purchase a coffee maker to brew coffee by themselves.

When brewing coffee powder with a coffee maker, first places a piece of coffee filter paper in a filter basket, and then fills the filter paper supported on the filter basket with a desired amount of coffee powder. Then, places the filter basket filled with coffee powder below a water outlet of the coffee maker. When hot water flows from the water outlet to contact with the coffee powder, brewed coffee can be formed to flow into a coffee cup.

In the process of brewing coffee powder using the commonly seen coffee maker, since the water outlet on the coffee maker is fixed in position and not freely changeable, the hot water dispensed from the water outlet can usually contact with only a small part of the coffee powder, preventing the coffee powder from being uniformly brewed, and the brewed coffee would be light in flavor without good aroma.

### SUMMARY OF THE INVENTION

A primary object of the present invention is provide an improved beverage maker, a water dispensing pipe of which can revolve about a rotation axis while moving linearly in a reciprocating motion, such that the water dispensed from the water dispensing pipe is in the form of a conical or an inverted conical helical flow, which imitates and achieves the same good effect of hand pour coffee brewing because the helically dispensed brewing water can uniformly contact with the brewing substance to produce beverage of rich flavor.

Another object of the present invention is to provide the above beverage maker that includes well organized components to largely reduce an overall volume of the beverage maker.

To achieve the above and other objects, the beverage maker with helically dispensed brewing water according to a first preferred embodiment of the present invention includes a fixed support, a rotating mechanism, a reciprocating mechanism, and a water dispensing pipe.

The rotating mechanism includes a movable support movably connected to the fixed support and a driving source connected to the fixed support. The movable support is provided with an elongated guide slot. The driving source is capable of driving the movable support to rotate about a rotation axis.

The reciprocating mechanism is provided on the movable support to rotate synchronously with the movable support. The reciprocating mechanism includes a moving member, a first rotation gear, and a second rotation gear. The moving member is provided with a gear rack. The first rotation gear is rotatably connected to the movable support and includes a first gear section dislocated from the gear rack and a first half gear section adapted to engage with or disengage from the gear rack. The first rotation gear is rotatable in a first rotation direction for the first half gear section to engage with and disengage from the gear rack alternately, such that a connection relation between the moving member and the first rotation gear is switched between a first engaged state, in which the first half gear section is engaged with the gear rack, and a first disengaged state, in which the first half gear section is disengaged from the gear rack. The second rotation gear is rotatably connected to the movable support and includes a second gear section dislocated from the gear rack and a second half gear section adapted to engage with and disengage from the gear rack alternately. The second gear section is engaged with the first gear section and is rotatable in a second rotation direction that is opposite to the first rotation direction, while the second half gear section is engaged with and disengaged from the gear rack alternately, such that a connection relation between the moving member and the second rotation gear is switchable between a second engaged state, in which the second half gear section is engaged with the gear rack, and a second disengaged state, in which the second half gear section is disengaged from the gear rack.

When the connection relation between the moving member and the first rotation gear is switched from the first disengaged state to the first engaged state, the moving member and the second rotation gear are in the second disengaged state, such that the first rotation gear rotating in the first rotation direction brings the moving member to move in a first direction. On the other hand, when the connection relation between the moving member and the first rotation gear is switched from the first engaged state to the first disengaged state, the moving member and the second rotation gear are in the second engaged state, and the second rotation gear rotating in the second rotation direction brings the moving member to move in a second direction that is opposite to the first direction.

The water dispensing pipe is connected to the moving member. When the movable support rotates, the water dispensing pipe is brought by the movable support to revolve about the rotation axis while it is also brought by the moving member to move in one of the first and the second direction.

In a second preferred embodiment of the present invention, the beverage maker with helically dispensed brewing water includes a fixed support, a rotating mechanism, a reciprocating mechanism, and a water dispensing pipe.

The rotating mechanism includes a movable support rotatably connected to the fixed support and a driving source connected to the fixed support. The movable support is provided with an elongated guide slot. The driving source drives the movable support to rotate about a rotation axis.

The reciprocating mechanism is provided on the movable support to be rotatable synchronously with the movable support, and includes a shifting member and a rotation gear. The shifting member includes a first gear rack and a second gear rack spaced from each other. The rotation gear is rotatably connected to the movable support and includes a half gear section located between the first gear rack and the second gear rack. The half gear section is rotatable, such that a connection relation between the shifting member and the rotation gear is switchable sequentially from a first operational state to a first idle state, a second operational state, and a second idle state. In the first operational state, the half gear section is engaged with the first gear rack; in the first idle state, the half gear section is disengaged from the first gear rack; in the second operational state, the half gear section is engaged with the second gear rack; and in the second idle state, the shifting member is disengaged from the second gear rack.

When the connection relation between the shifting member and the rotation gear is switched from the second idle state to the first operational state, the half gear section is disengaged from the second gear rack, and the rotation gear in rotating brings the shifting member to move in a first direction. On the other hand, when the connection relation between the shifting member and the rotation gear is switched from the first idle state to the second operational state, the half gear section is disengaged from the first gear rack, and the rotation gear in rotating brings the shifting member to move in a second direction that is opposite to the first direction.

The water dispensing pipe is connected to the shifting member. When the movable support rotates, the water dispensing pipe is brought by the movable support to revolve about the rotation axis while it is also brought by the shifting member to move in one of the first and the second direction.

In the above two embodiments, the fixed support is provided with a fixed hole, through which the movable support is extended, and an internal gear is formed on an inner circumferential surface of the fixed hole. The internal gear is engaged with the first gear section via a transmission mechanism mounted on the movable support, such that the transmission mechanism brings the first rotation gear to rotate in the first rotation direction and the moving member is moved in one of the first and the second direction when the movable support rotates about the rotation axis.

Further, the transmission mechanism includes a driving gear engaged with the internal gear, a driven gear engaged with the first gear section, and an intermediate gear provided between the driving gear and the driven gear; and all the driving gear, the driven gear, and the intermediate gear are located within the fixed hole. Further, the moving member, the first rotation gear, and the second rotation gear all are located within the fixed hole.

The fixed support includes a fixed vertical plate, a fixed horizontal plate extended from a lower edge of the fixed vertical plate, and a fixed suspension plate extended from an upper edge of the fixed vertical plate to be located above and spaced from the fixed horizontal plate. The internal gear is formed on the fixed horizontal plate, and the fixed suspension plate is provided with a fixed connection hole that extends through the fixed suspension plate and is located above the fixed hole.

The movable support includes a movable vertical plate, a movable horizontal plate extended from a lower edge of the movable vertical plate and having the elongated guide slot provided thereon, and a movable connection plate extended from an upper edge of the movable vertical plate and located above and spaced from the movable horizontal plate. The movable connection plate has a hollow connection cylinder for extending through the fixed connection hole on the fixed suspension plate, and the hollow connection cylinder internally defines a movable connection bore, which axially extends through the hollow connection cylinder and is located above the fixed hole. Further, the movable vertical plate is extended through the fixed hole, such that the movable horizontal plate and the movable connection plate are located at a lower and an upper side of the fixed hole, respectively, and both of the movable horizontal plate and the movable connection plate are axially located outside the fixed hole.

The present invention is characterized in that the reciprocating mechanism includes the half gear sections and the gear racks to move the moving member linearly; and that the water dispensing pipe is brought by the rotating movable support to revolve about the rotation axis while it is brought by the movable support to move linearly in a reciprocating motion. Therefore, water dispensed from the water dispensing pipe is in the form of a conical helical flow or an inverted conical helical flow, which imitates the hand pour coffee brewing to achieve the same good coffee brewing effect, because the brewing water can uniformly contact with the brewing substance to produce beverage of rich flavor.

Further, both the reciprocating mechanism and the transmission mechanism include a plurality of parallel gears that have centerlines or rotation axes parallel with each other, such that the beverage maker with helically dispensed brewing water can have an effectively reduced overall volume without influencing the revolution or linear movement of the water dispensing pipe.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a top perspective view of a beverage maker with helically dispensed brewing water according to a first preferred embodiment of the present invention, viewed from a front side thereof;

FIG. 2 is an exploded view of the beverage maker of FIG. 1, viewed from a rear side thereof;

FIG. 3 is a cutaway view of the beverage maker of FIG. 1, viewed from a front side thereof;

FIG. 4 is a sectional top view showing a reciprocating mechanism in the beverage maker of FIG. 1 is connected to a movable support;

FIG. 5A shows the movable support in the beverage maker of the present invention is brought by a driving source to rotate;

FIG. 5B shows a water dispensing pipe in the beverage maker of the present invention is moved along a first direction;

FIG. 5C is a bottom perspective view of the beverage maker of the present invention, showing brewing water is dispensed in the form of an inverted conical helical flow that tapers downward;

FIG. 5D shows the water dispensing pipe in the beverage maker of the present invention is moved along a second direction;

FIG. 5E shows the brewing water is dispensed in the form of a conical helical flow that tapers upward;

FIG. 6 is a sectional top view of a beverage maker according to a second preferred embodiment of the present invention;

FIG. 7A shows a half gear section is disengaged from a second gear rack in the beverage maker according to the second preferred embodiment of the present invention;

FIG. 7B shows the half gear section is engaged with a first gear rack;

FIG. 7C shows the half gear section is disengaged from the first gear rack; and

FIG. 7D shows the half gear section is engaged with the second gear rack.

### DETAILED DESCRIPTION OF THE PREFERRED EMBODIMENTS

The present invention will now be described with some preferred embodiments thereof and by referring to the accompanying drawings. For the purpose of easy to understand, elements that are the same in the preferred embodiments are denoted by the same reference numerals.

In the drawings, two opposite ends of the x-axis indicate a left and a right side of the beverage maker of the present invention when viewing in front of the drawings; two opposite ends of the y-axis indicate a front and a rear side of the beverage maker of the present invention when viewing in front of the drawings; and two opposite ends of the z-axis indicate an upper and a lower side of the beverage maker of the present invention when viewing in front of the drawings. Further, the directional terms “front”, “rear”, “left”, “right”, “upper”, and “lower” shown in the specification hereinafter are used to describe the directional positions of the beverage maker of the present invention when a user faces toward the beverage maker.

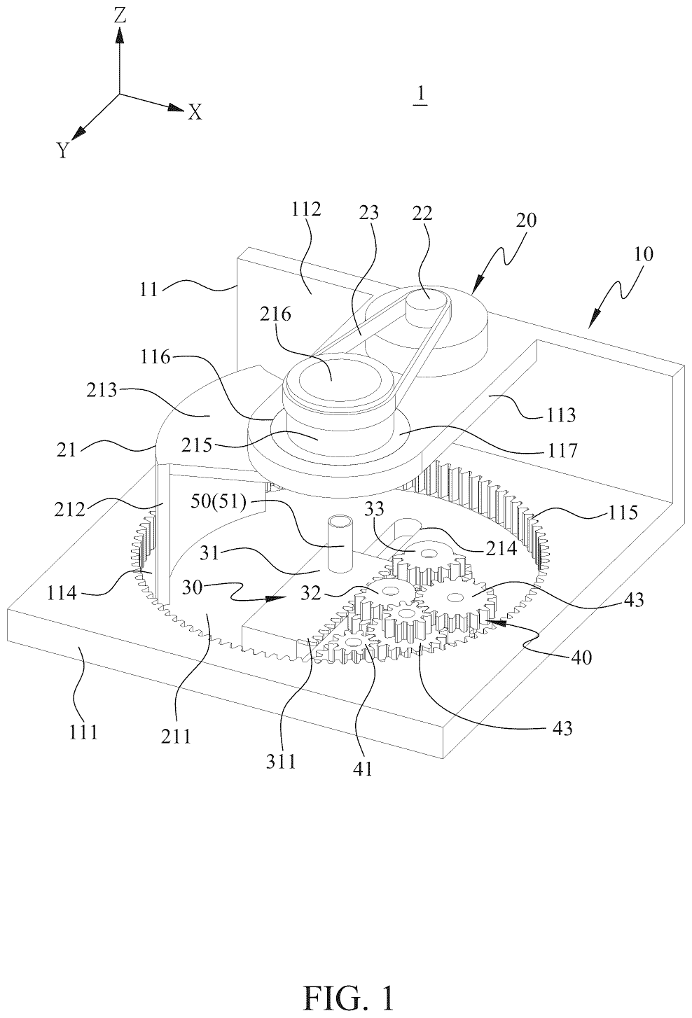

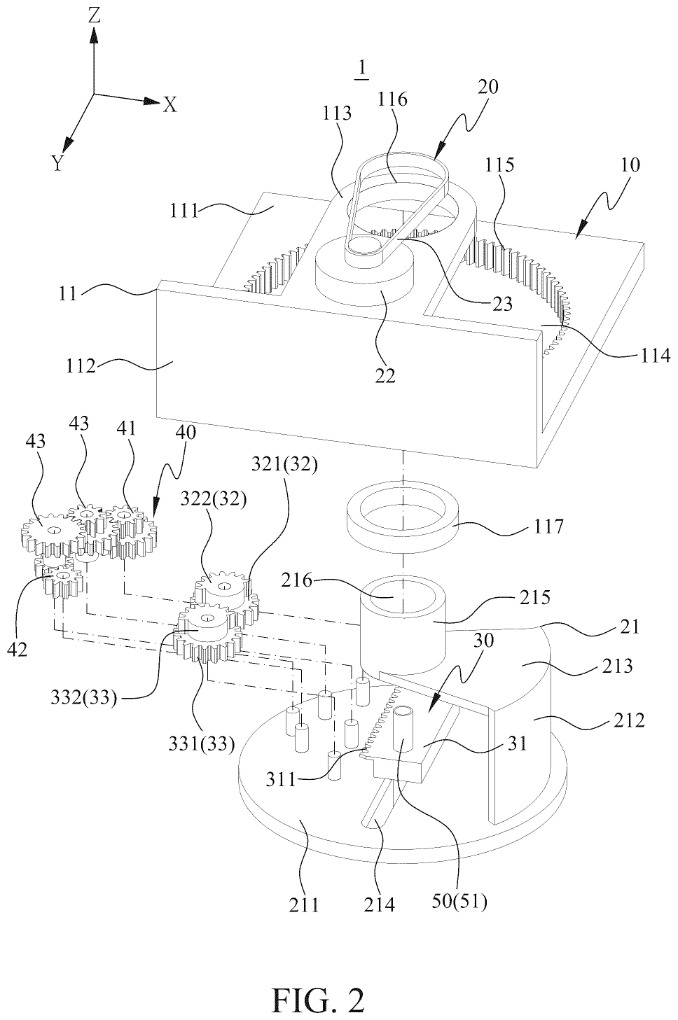

Please refer to FIGS. 1 and 2. In a first preferred embodiment, the beverage maker 1 with helically dispensed brewing water according to the present invention mainly includes a base 10, a rotating mechanism 20, a reciprocating mechanism 30, a transmission mechanism 40, and a water dispensing mechanism 50. For the purpose of conciseness and clarity, the present invention is also briefly referred to as the beverage maker 1 herein. The base 10 includes a fixed support 11 located at a highest position of the base 10. As shown, the fixed support 11 includes a fixed horizontal plate 111 forming a lowest position of the fixed support 11, a fixed vertical plate 112 substantially perpendicularly extended upward from an edge of the fixed horizontal plate 111 along z-axis, and a fixed suspension plate 113 forward extended from an edge of the fixed vertical plate 112 opposite to the fixed horizontal plate 111 along y-axis, such that the fixed suspension plate 113 is located above and vertically spaced from the fixed horizontal plate 111. The fixed horizontal plate 111 of the fixed support 11 is provided with a fixed hole 114 that penetrates the fixed horizontal plate 111 and has an inner wall surface formed into an internal gear 115. The fixed suspension plate 113 is provided with a fixed connection hole 116 that penetrates the fixed suspension plate 113 and is located above the fixed hole 114. The fixed connection hole 116 has a bearing 117 mounted therein.

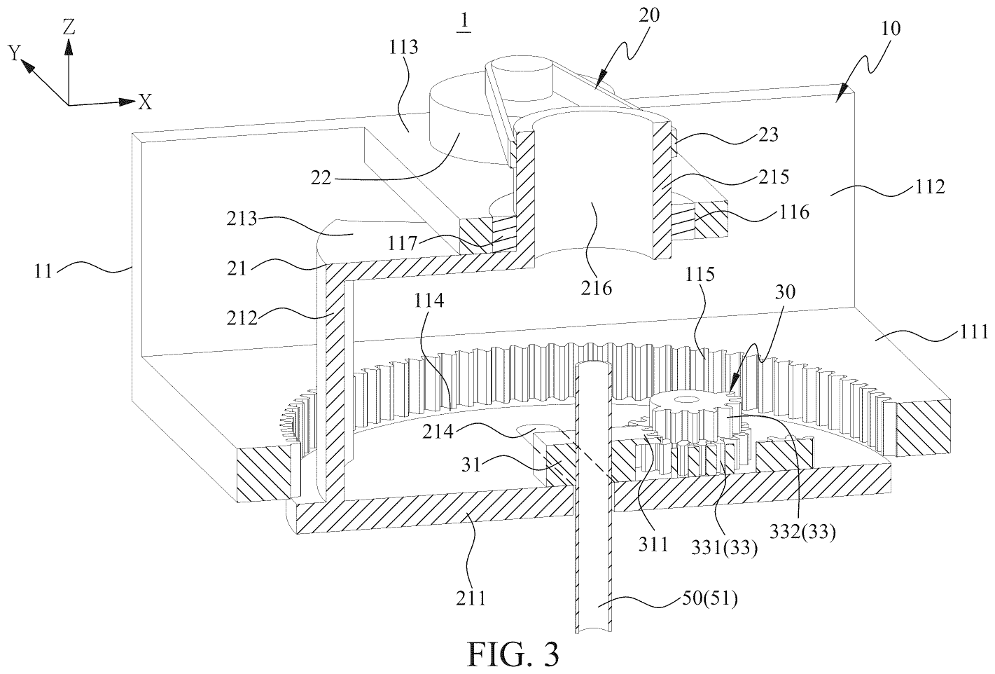

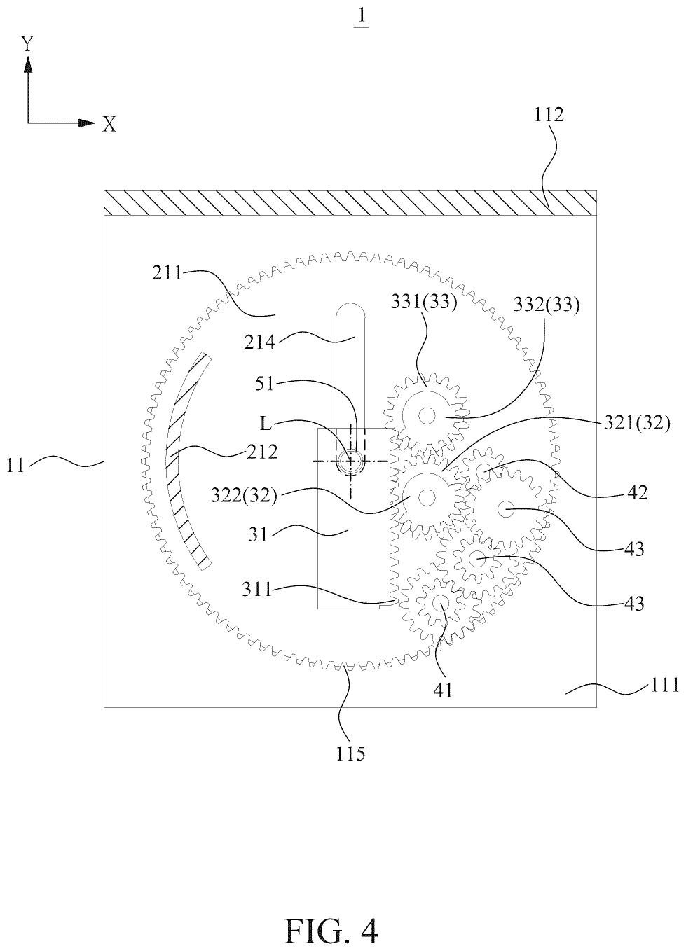

As shown in FIGS. 1 and 2, the rotating mechanism 20 includes a movable support 21 and a driving source 22. The movable support 21 includes a movable horizontal plate 211 forming a lowest portion of the movable support 21, a movable vertical plate 212 substantially perpendicularly extended upward from an upper side of the movable horizontal plate 211 along z-axis, and a movable connection plate 213 horizontally extended from an upper edge of the movable vertical plate 212 opposite to the movable horizontal plate 211 along y-axis, such that the movable connection plate 213 is located in parallel to the movable horizontal plate 211. As shown, the movable horizontal plate 211 is provided with an elongated guide slot 214, which is located below the movable connection plate 213. The movable connection plate 213 is provided with a hollow movable connection cylinder 215, which is upward extended from one side of the movable connection plate 213 opposite to the movable horizontal plate 211 along z-axis and internally defines a movable connection bore 216 that extends through the movable connection cylinder 215 in the direction of z-axis. As can be seen in FIG. 3, the movable connection cylinder 215 is extended through the fixed connection hole 116 on the fixed support 11 and passes through the bearing 117 to be movably connected to the fixed suspension plate 113. With the bearing 117, the movable support 21 is rotatable relative to the fixed support 11. When the movable connection cylinder 215 is extended through the fixed connection hole 116, the movable vertical plate 212 is also extended through the fixed hole 114 of the fixed support 11, such that the movable horizontal plate 211 and the movable connection plate 113 are located below and above the fixed hole 114, respectively, to be located outside the fixed hole 114 in the direction of z-axis. The movable connection bore 216 is spaced from the fixed hole 114 in the direction of z-axis, and the movable connection bore 216 is located at a position higher than that of the fixed hole 114 in the z-axis direction. Please refer to FIG. 2. The driving source 22 is connected to the fixed suspension plate 113 of the fixed support 11 and is connected to the movable connection cylinder 215 via an endless belt 23, such that the driving source 22 can bring the movable support 21 to rotate about a rotation axis L, as shown in FIG. 4.

Please refer to FIGS. 2 and 4. The reciprocating mechanism 30 is provided on the movable horizontal plate 211 of the movable support 21, so that it is located between the movable horizontal plate 211 and the movable connection plate 213 of the movable support 21. When the driving source 22 of the rotating mechanism 20 drives the movable support 21 to rotate, the reciprocating mechanism 30 rotates synchronously with the movable support 21. In the first preferred embodiment, the reciprocating mechanism 30 includes a moving member 31, a first rotation gear 32, and a second rotation gear 33 located within the fixed hole 114. The moving member 31 is movably connected to an upper surface of the movable horizontal plate 211 to be movable transversely in the elongated guide slot 214 on the movable horizontal plate 211. The moving member 31 has one lateral side formed into a gear rack 311.

The first rotation gear 32 of the reciprocating mechanism 30 is rotatably connected to the movable horizontal plate 211 of the movable support 21. The first rotation gear 32 includes a first gear section 321 and a first half gear section 322 that has a contour smaller than that of the first gear section 321. As shown in FIG. 4, the first gear section 321 is provided along a full outer circumferential surface with a plurality of equally spaced teeth and is dislocated from the moving member 31 to engage with only a lower part of the gear rack 311 of the moving member 31. The first half gear section 322 is provided along only one half of its outer circumferential surface with a plurality of equally spaced teeth, while the other half of its outer circumferential surface is a smooth surface. In the first preferred embodiment, an elevation of the first half gear section 322 in the direction of z-axis is generally the same as that of the gear rack 311 of the moving member 31. When the first rotation gear 32 rotates relative to the movable horizontal plate 211, the first half gear section 322 is either engaged with or disengaged from the gear rack 311. Therefore, a connection relation between the moving member 31 and the first rotation gear 32 is switchable between a first engaged state A1 and a first disengaged state A2. In the first engaged state A1, the first half gear section 322 is engaged with the gear rack 311, and in the first disengaged state A2, the first half gear section 322 is disengaged from the gear rack 311.

The second rotation gear 33 of the reciprocating mechanism 30 is rotatably connected to the movable horizontal plate 211 of the movable support 21. The second rotation gear 33 includes a second gear section 331 and a second half gear section 332 that has a contour smaller than that of the second gear section 331. As shown in FIG. 4, the second gear section 331 has a structural configuration the same as that of the first gear section 321 of the first rotation gear 32 and has a plurality of teeth equally spaced along a full outer circumferential surface thereof. The second gear section 331 is dislocated from the moving member 31 to engage with only a lower part of the gear rack 311 of the moving member 31 and is engaged with the first gear section 321 of the first rotation gear 32, such that the first rotation gear 32 and the second rotation gear 33 rotate simultaneously in two opposite directions. The second half gear section 332 is provided on only one half of its outer circumferential surface with a plurality of equally spaced teeth, and its remaining half outer circumferential surface is a smooth surface. In the first preferred embodiment, an elevation of the second half gear 332 in z-axis direction is generally the same as that of the first half gear section 322. When the second rotation gear 33 rotates relative to the movable horizontal plate 211, the second half gear section 332 is either engaged with or disengaged from the gear rack 311. Therefore, a connection relation between the moving member 31 and the second rotation gear 33 is switchable between a second engaged state A3 and a second disengaged state A4. In the second engaged state A3, the second half gear section 332 is engaged with the gear rack 311, and in the second disengaged state A4, the second half gear section 332 is disengaged from the gear rack 311.

Please refer to FIGS. 2 and 4. The transmission mechanism 40 is provided on the movable horizontal plate 211 of the movable support 21 and is connected to the internal gear 115 of the fixed support 11 and the first gear section 321 of the first rotation gear 32. When the movable support 21 of the rotating mechanism 20 is brought by the driving source 22 to rotate, the transmission mechanism 40 transmits the movement of the movable support 21 to the first and the second rotation gear 32, 33, so that the first and the second rotation gear 32, 33 rotate at the same time in two opposite directions. In the first preferred embodiment, the transmission mechanism 40 includes a driving gear 41, a driven gear 42, and two intermediate gears 43 located within the fixed hole 114 of the fixed support 11. The driving gear 41 meshes with the internal gear 115, the driven gear 42 meshes with the first gear section 321, and the two intermediate gears 43 mesh with each other. And, the two intermediate gears 43 are located between the driving gear 41 and the driven gear 42, such that one of the two intermediate gears 43 is engaged with the driving gear 41 while the other one is engaged with the driven gear 42.

Please refer to FIGS. 2 and 3. The water dispensing mechanism 50 includes a water storage space (not shown) capable of storing an amount of water and a water dispensing pipe 51 communicable with the water storage space. The water storage space is provided inside the base 10 and the water dispensing pipe 51 is connected to the moving member 31 of the reciprocating mechanism 30. Further, the water dispensing pipe 51 is upward extended through the elongated guide slot 214 of the fixed support 21.

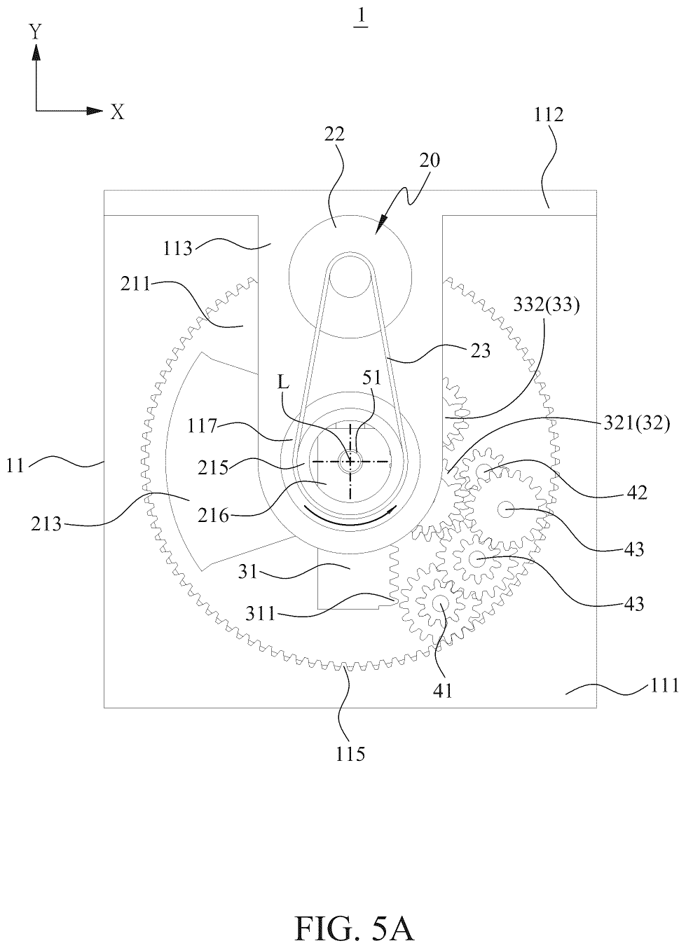

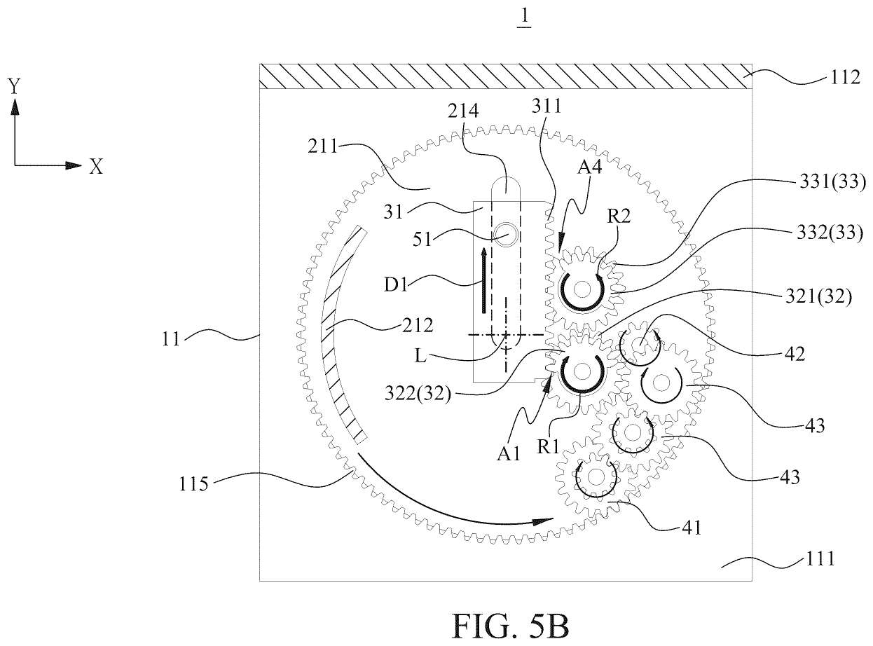

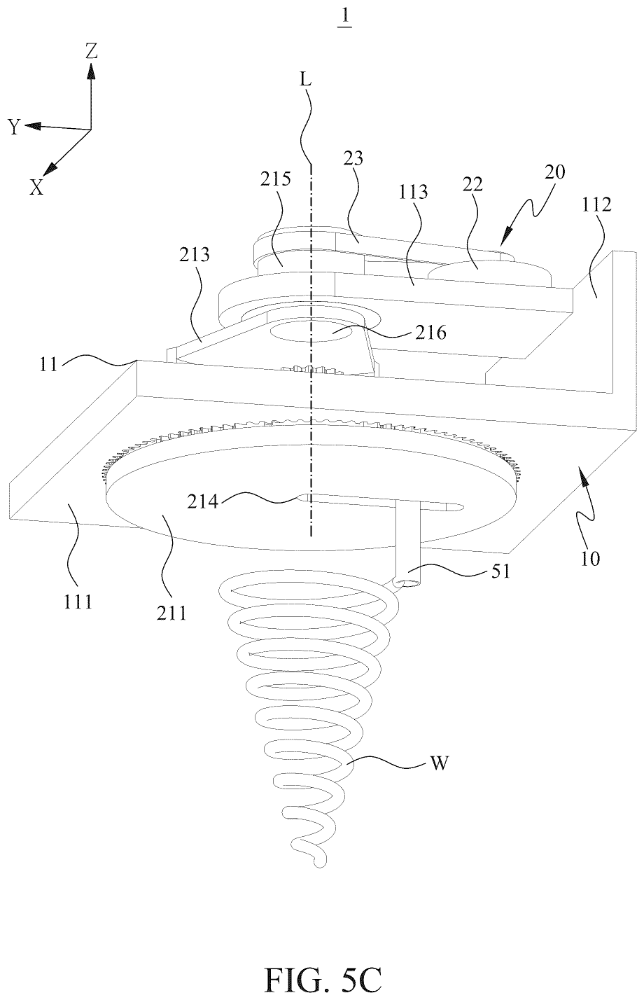

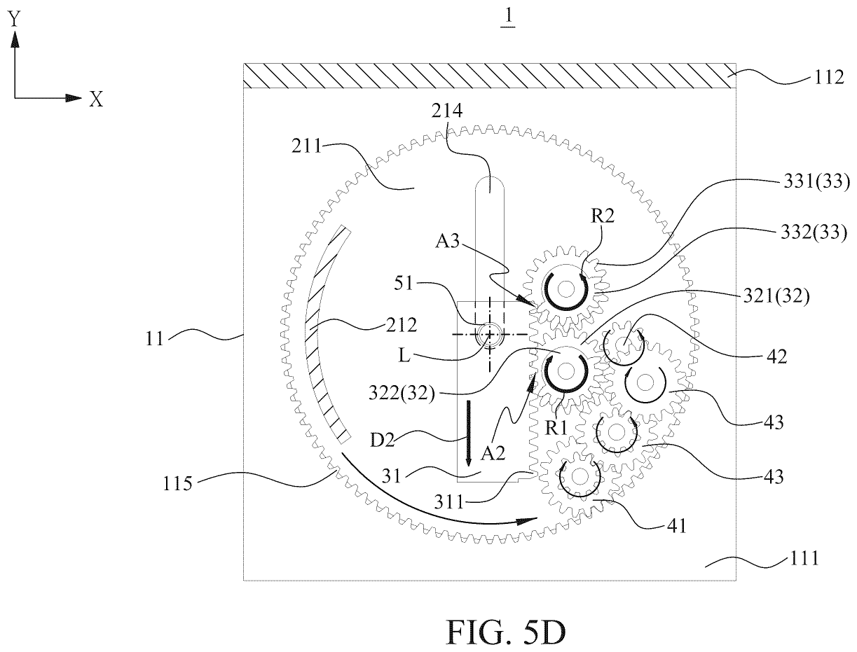

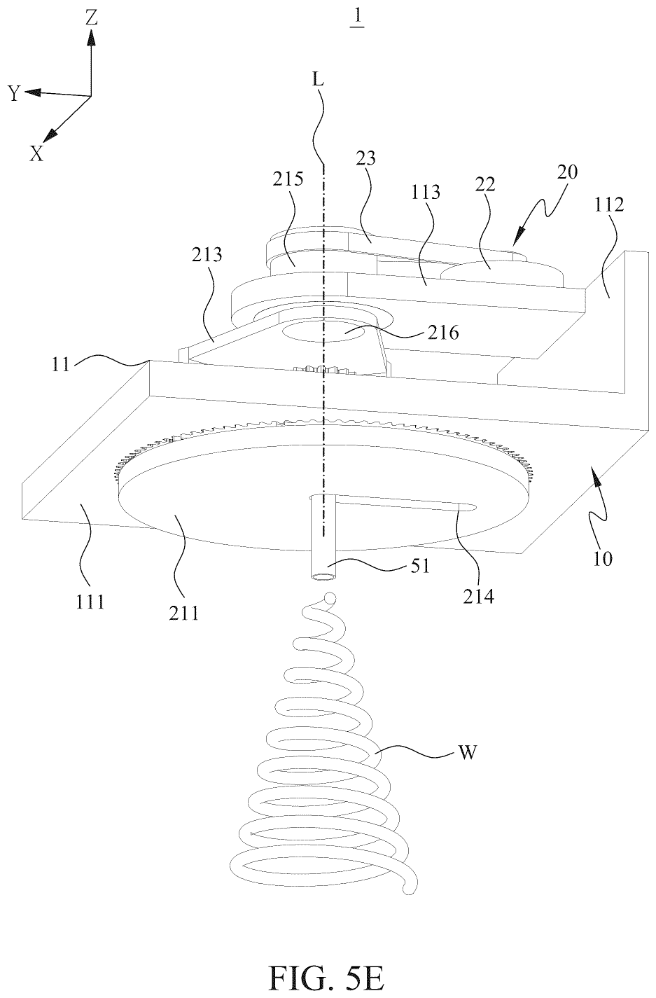

Please refer to FIGS. 5A, 5B and 5C for the practical application of the beverage maker 1 according to the first embodiment of the present invention. Firstly, the water dispensing mechanism 50 guides the water in the water storage space to the water dispensing pipe 51, such that the water can flow out of the water dispensing pipe 51 to supply an amount of brewing water W. Then, the driving source 22 of the rotating mechanism 20 brings the movable support 21 to rotate counterclockwise about the rotation axis L relative to the fixed support 11 on the base 10, such that the driving gear 41 is brought to revolve counterclockwise about the rotation axis L at the same time. Since the driving gear 41 of the transmission mechanism 40 meshes with the internal gear 115 of the fixed support 11, the driving gear 41 also rotates clockwise when the movable support 21 is rotated counterclockwise. At this point, the clockwise rotational motion of the driving gear 41 is transmitted via the two intermediate gears 43 to the driven gear 42 of the transmission mechanism 40, bringing the driven gear 42 to rotate counterclockwise, and the first rotation gear 32 of the reciprocating mechanism 30 also rotates clockwise in a first rotation direction R1. Meanwhile, since the first gear section 321 of the first rotation gear 32 is engaged with the second gear section 331 of the second rotation gear 33, the second rotation gear 33 is caused to rotate synchronously but in a second rotation direction R2 opposite to the first rotation direction R1, i.e. to rotate counterclockwise. When the first rotation gear 32 rotates in the first rotation direction R1, the connection relation between the moving member 31 and the first rotation gear 32 of the reciprocating mechanism 30 is switched from the first disengaged state A2 to the first engaged state A1, while the connection relation between the moving member 31 and the second rotation gear 33 is switched from the second engaged state A3 to the second disengaged state A4. Therefore, the moving member 31 is brought by the first rotation gear 32 rotating in the first rotation direction R1 to move and carries the water dispensing pipe 51 of the water dispensing mechanism 50 to move in a first direction D1, such that the water dispensing pipe 51 moves slowly in along the elongated guide slot 214 of the movable support 21 away from the rotation axis L gradually. In the first preferred embodiment, when the water dispensing pipe 51 is moving in the first direction D1, the movable support 21 keeps rotating counterclockwise about the rotation axis L, such that the water dispensing pipe 51 is also brought by the movable support 21 to revolve about the rotation axis L and the brewing water W is dispensed or poured on a brewing substance in the form of an inverted conical helical flow having a larger top diameter and a smaller bottom diameter.

Please refer to FIGS. 5D and 5E. The movable support 21 of the rotating mechanism 20 is continuously driven by the driving source 22 to rotate counterclockwise about the rotation axis L, such that the first rotation gear 32 of the reciprocating mechanism 30 keeps rotating in the first rotation direction R1, and the connection relation between the moving member 31 and the first rotation gear 32 is switched from the first engaged state A1 to the first disengaged state A2 while the connection relation between the moving member 31 and the second rotation gear 33 is switched from the second disengaged state A4 to the second engaged state A3. At this point, the second rotation gear 33 rotating in the second rotation direction R2 causes the moving member 31 to move the water dispensing pipe 51 in a second direction D2 opposite to the first direction D1, so that the water dispensing pipe 51 slowly moves in along the elongated guide slot 214 on the movable support 21 toward the rotation axis L gradually. In the first preferred embodiment, when the water dispensing pipe 51 moves in the second direction D2, the movable support 21 keeps rotating counterclockwise about the rotation axis L, so that the water dispensing pipe 51 is brought by the movable support 21 to revolve counterclockwise at the same time. Therefore, the brewing water W is dispensed or poured on the brewing substance in the form of a conical helical flow having a smaller top diameter and a larger bottom diameter.

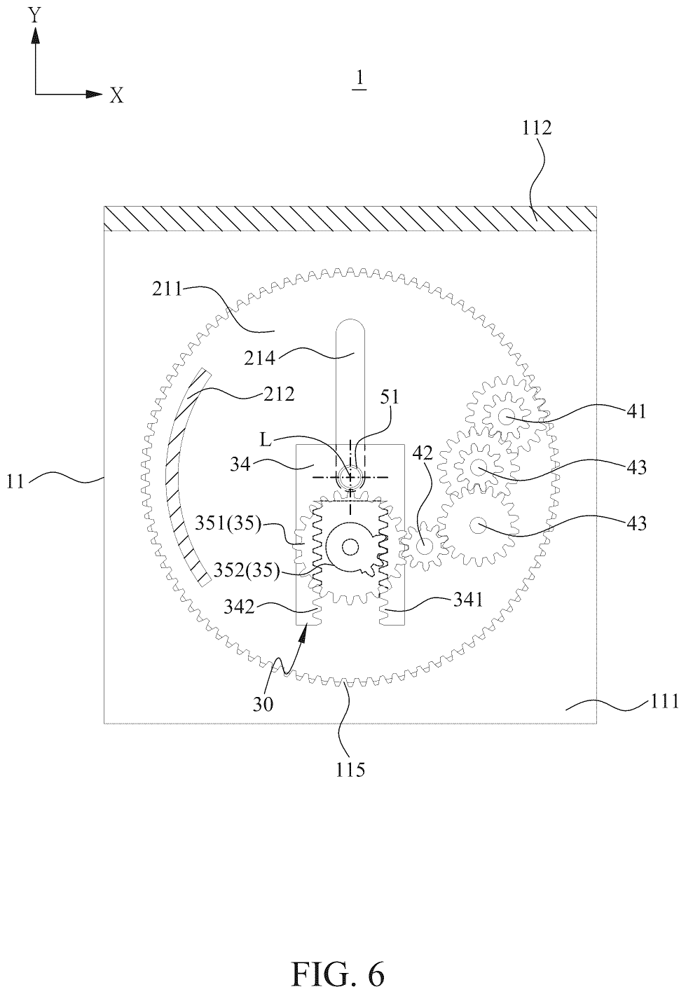

Please refer to FIG. 6. A beverage maker 1 according to a second preferred embodiment of the present invention is different from that in the first preferred embodiment in having a differently structured reciprocating mechanism 30. Since the base 10, the rotating mechanism 20, the transmission mechanism 40, and the water dispensing mechanism 50 all are the same as those in the first preferred embodiment, they are not repeatedly described herein. As shown in FIG. 6, the reciprocating mechanism 30 in the second preferred embodiment is provided on the movable horizontal plate 211 of the movable support 20, so that the reciprocating mechanism 30 rotates synchronously with the movable support 21. In the second preferred embodiment, the reciprocating mechanism 30 includes a shifting member 34 and a rotation gear 35 located within the fixed hole 114 of the fixed support 11. The shifting member 34 is movably connected to the upper surface of the movable horizontal plate 211 and has the water dispensing pipe 51 of the water dispensing mechanism 50 connected thereto, such that the shifting member 34 can move transversely in along the elongated guide slot 214 on the movable horizontal plate 211. Further, the shifting member 34 is provided with a first gear rack 341 and a second gear rack 342 parallelly spaced from each other.

As shown in FIG. 6, the rotation gear 35 of the reciprocating mechanism 30 is rotatably connected to the movable horizontal plate 211 of the movable support 21 and includes a gear section 351 and a half gear section 352 that has a contour smaller than that of the gear section 351. An elevation of the gear section 351 in the z-axis direction is higher than the shifting member 34 for engaging with the driven gear 42 of the transmission mechanism 40. A plurality of teeth is equally spaced along an entire circumferential surface of the gear section 351. The half gear section 352 is located between the first and the second gear rack 341, 342 of the shifting member 34. A plurality of teeth is equally spaced along only one half of a circumferential surface of the half gear section 352, while the remaining half circumferential surface of the half gear section 352 is a smooth surface. In the second preferred embodiment, when the rotation gear 35 rotates relative to the movable horizontal plate 211, a connection relation between the shifting member 34 and the rotation gear 35 switches sequentially from a first operational state A5 to a first idle state A6, a second operational state A7, and a second idle state A8. In the first operational state A5, the half gear section 352 is engaged with the first gear rack 341; in the first idle state A6, the half gear section 352 is disengaged from the first gear rack 341; in the second operational state A7, the half gear section 352 is engaged with the second gear rack 342, and in the second idle state A8, the half gear section 352 is disengaged from the second gear rack 342.

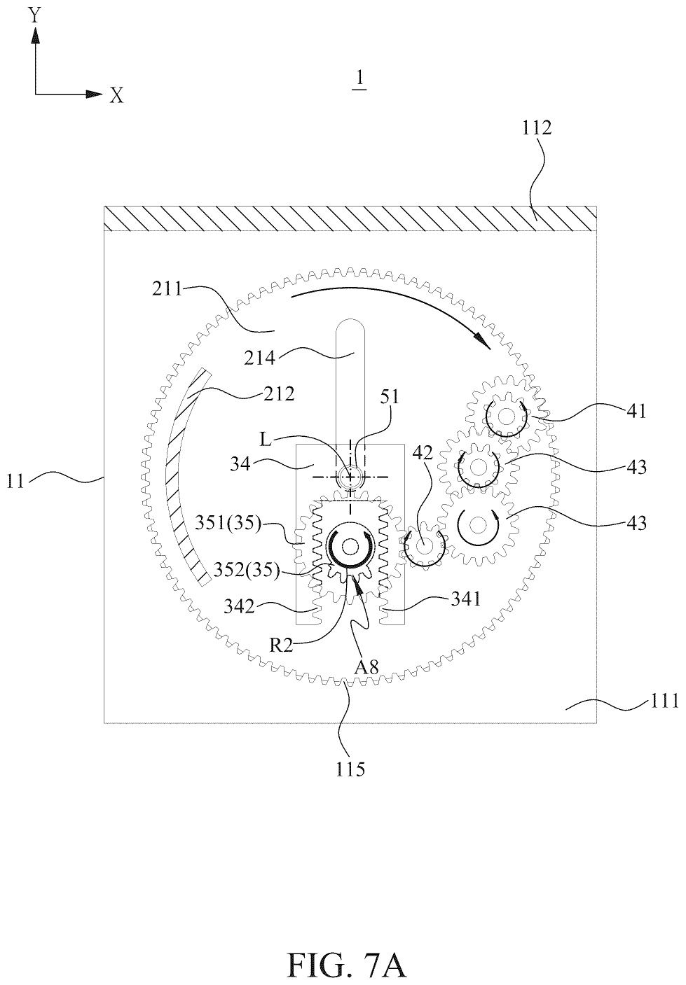

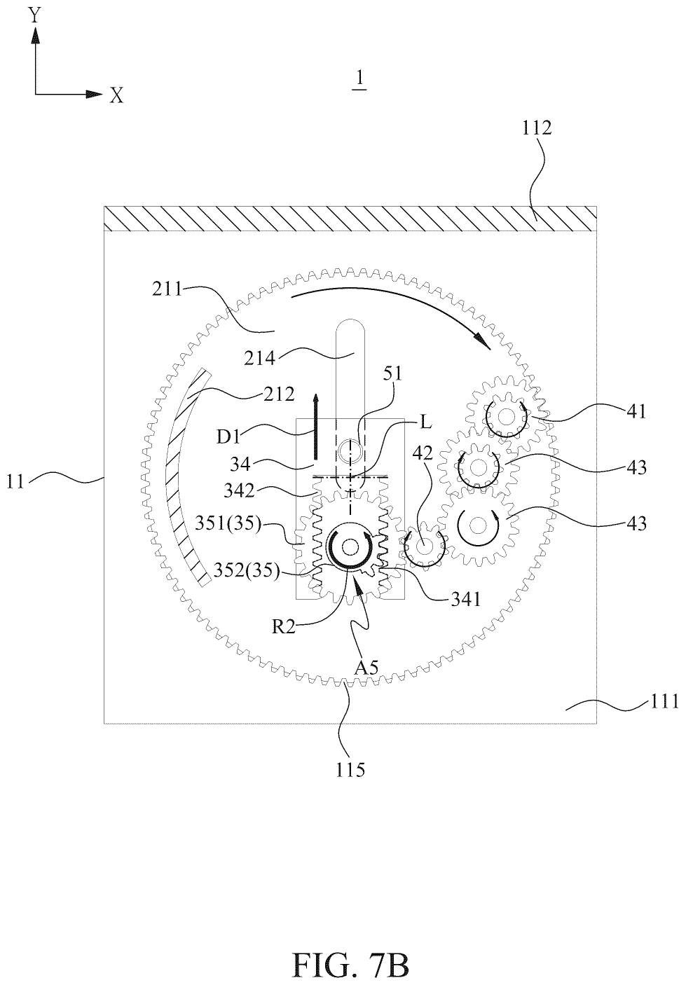

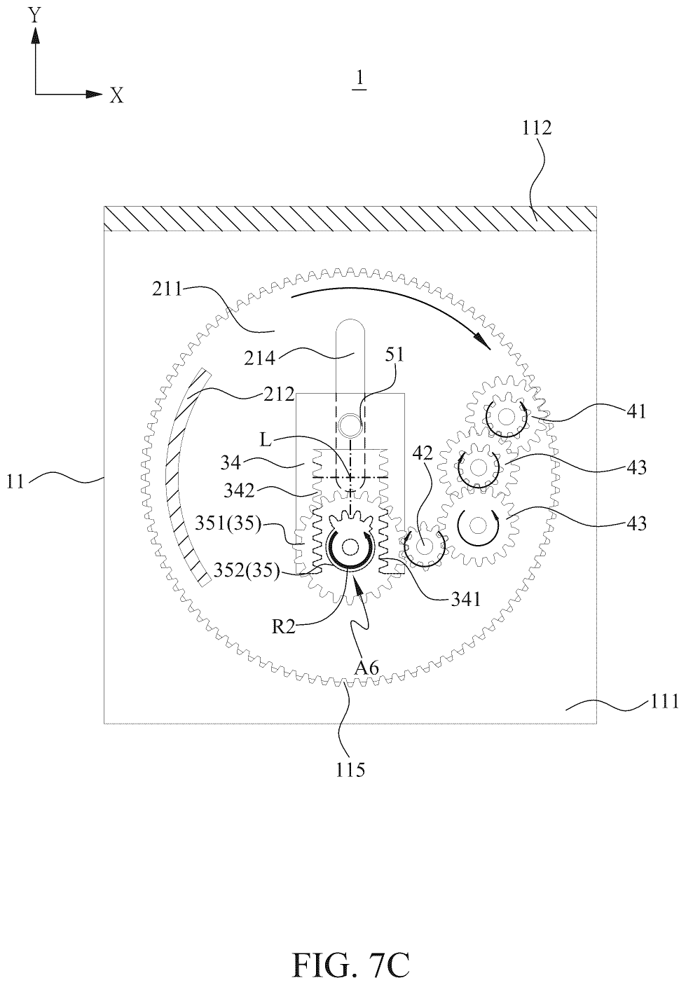

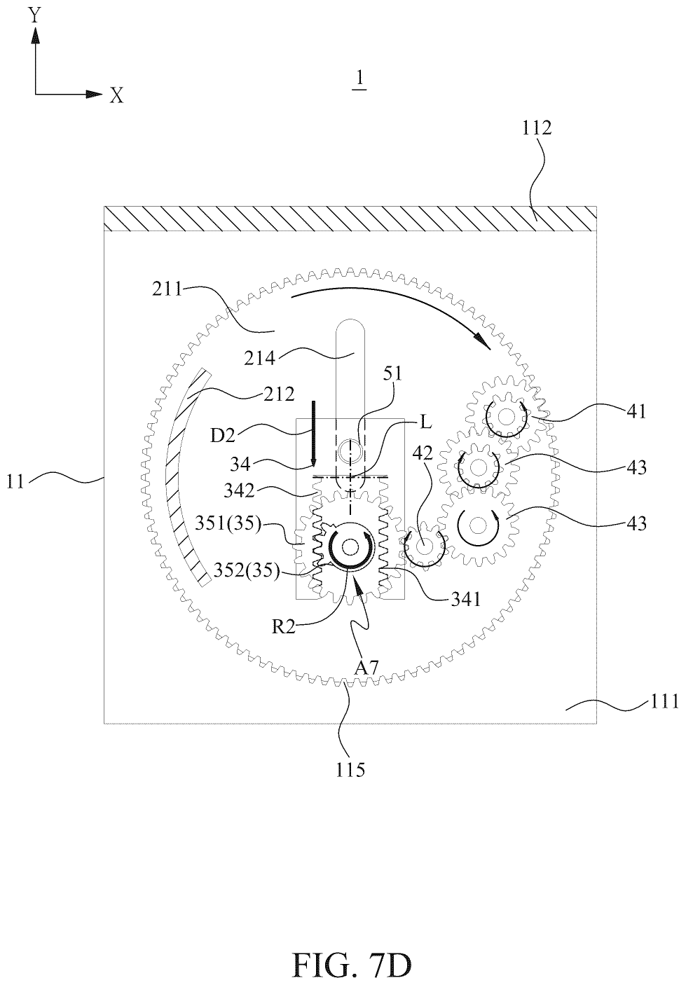

Please refer to FIGS. 7A and 7B. The driving source 22 of the rotating mechanism 20 drives the movable support 21 to rotate clockwise about the rotation axis L relative to the fixed support 11 of the base 10. Since the driving gear 41 of the transmission mechanism 40 is engaged with the internal gear 115 on the fixed support 11, the driving gear 41 would rotate counterclockwise when the movable support 21 rotates clockwise, and the counterclockwise rotational motion of the driving gear 41 is transmitted via the two intermediate gears 43 of the transmission mechanism 40 to bring the driven gear 42 to rotate clockwise, which in turn causes the rotation gear 35 of the reciprocating mechanism 30 to rotate in the second rotation direction R2. When the rotation gear 35 rotates in the second rotation direction R2, the connection relation between the shifting member 34 and the rotation gear 35 is switched from the second idle state A8 (see FIG. 7A) to the first operational state A5 (see FIG. 7B), i.e. the half gear section 352 is disengaged from the second gear rack 342 of the shifting member 34. Meanwhile, when the rotation gear 35 rotates in the second rotation direction R2, the water dispensing pipe 51 of the water dispensing mechanism 50 connected to the shifting member 34 is brought to move in the first direction D1 at the same time. In the second preferred embodiment, when the water dispensing pipe 51 moves in the first direction D1, the movable support 21 rotating clockwise also brings the water dispensing pipe 51 to revolve about the rotation axis L at the same time, such that the brewing water W from the water dispensing pipe 51 is dispensed or poured on a brewing substance in the form of an inverted conical helical flow having a larger top diameter and smaller bottom diameter.

Please refer to FIGS. 7C and 7D. When the movable support 21 of the rotating mechanism 20 is driven by the driving source 22 to keep rotating clockwise about the rotation axis L, the rotation gear 35 of the reciprocating mechanism 30 also keeps rotating in the second rotation direction R2, and the connection relation between the shifting member 34 of the reciprocating mechanism 30 and the rotation gear 35 is switched sequentially from the first operational state A5 to the first idle state A6 and then the second operational state A7, such that the half gear section 352 is disengaged from the first gear rack 341 of the shifting member 34. At this point, the rotation gear 35 rotating in the second rotation direction R2 also brings the water dispensing pipe 51 connected to the shifting member 34 to move in the second direction D2, such that the water dispensing pipe 51 moves slowly in along the elongated guide slot 214 on the movable support 21 toward the rotation axis L gradually. In the second preferred embodiment, when the water dispensing pipe 51 is moved in the second direction D2, the movable support 21 rotating clockwise brings the water dispensing pipe 51 to revolve about the rotation axis L at the same time, such that the brewing water W from the water dispensing pipe 51 is dispensed or poured on the brewing substance in the form of a conical helical flow having a smaller top diameter and a larger bottom diameter.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A beverage maker with helically dispensed brewing water, comprising:
a fixed support;
a rotating mechanism including a movable support movably connected to the fixed support and a driving source connected to the fixed support; the movable support being provided with an elongated guide slot; and the driving source being capable of driving the movable support to rotate about a rotation axis;
a reciprocating mechanism being provided on the movable support to rotate synchronously with the movable support; the reciprocating mechanism including:
a moving member being provided with a gear rack and movable in along the elongated guide slot;
a first rotation gear being rotatably connected to the movable support and including a first gear section dislocated from the gear rack and a first half gear section engaging with and disengaging from the gear rack alternately; the first rotation gear being rotatable in a first rotation direction for the first half gear section to engage with or disengage from the gear rack, such that a connection relation between the moving member and the first rotation gear is switchable between a first engaged state, in which the first half gear section is engaged with the gear rack, and a first disengaged state, in which the first half gear section is disengaged from the gear rack; and
a second rotation gear being rotatably connected to the movable support and including a second gear section dislocated from the gear rack and a second half gear section engaging with and disengaging from the gear rack alternately; the second gear section being engaged with the first gear section and being rotatable in a second rotation direction opposite to the first rotation direction for the second half gear section to engage with or disengage from the gear rack, such that a connection relation between the moving member and the second rotation gear is switchable between a second engaged state, in which the second half gear section is engaged with the gear rack, and a second disengaged state, in which the second half gear section is disengaged from the gear rack;
wherein, when the connection relation between the moving member and the first rotation gear is switched from the first disengaged state to the first engaged state, the connection relation between the moving member and the second rotation gear is in the second disengaged state, and the first rotation gear rotating in the first rotation direction brings the moving member to move in a first direction; and
wherein, when the connection relation between the moving member and the first rotation gear is switched from the first engaged state to the first disengaged state, the connection relation between the moving member and the second rotation gear is in the second engaged state, and the second rotation gear rotating in the second rotation direction brings the moving member to move in a second direction that is opposite to the first direction; and
a water dispensing pipe being connected to the moving member, such that the movable support in rotating brings the water dispensing pipe to revolve about the rotation axis at the same time; meanwhile, the water dispensing pipe being brought by the moving member to move in one of the first direction and the second direction.

2. The beverage maker with helically dispensed brewing water as claimed in claim 1, wherein the fixed support is provided with a fixed hole, through which the movable support is extended, and an internal gear formed on an inner circumferential surface of the fixed hole; the internal gear being engaged with the first gear section via a transmission mechanism mounted on the movable support, such that the transmission mechanism brings the first rotation gear to rotate in the first rotation direction and the moving member is moved in one of the first and the second direction when the movable support rotates about the rotation axis.

3. The beverage maker with helically dispensed brewing water as claimed in claim 2, wherein the transmission mechanism includes a driving gear engaged with the internal gear, a driven gear engaged with the first gear section, and an intermediate gear provided between the driving gear and the driven gear; and all the driving gear, the driven gear, and the intermediate gear being located within the fixed hole.

4. The beverage maker with helically dispensed brewing water as claimed in claim 2, wherein the moving member, the first rotation gear, and the second rotation gear all are located within the fixed hole.

5. The beverage maker with helically dispensed brewing water as claimed in claim 2, wherein the fixed support includes a fixed vertical plate, a fixed horizontal plate extended from a lower edge of the fixed vertical plate, and a fixed suspension plate extended from an upper edge of the fixed vertical plate to be located above and spaced from the fixed horizontal plate; the internal gear being formed on the fixed horizontal plate, and the fixed suspension plate being provided with a fixed connection hole that extends through the fixed suspension plate and is located above the fixed hole.

6. The beverage maker with helically dispensed brewing water as claimed in claim 5, wherein the movable support includes a movable vertical plate, a movable horizontal plate extended from a lower edge of the movable vertical plate and having the elongated guide slot provided thereon, and a movable connection plate extended from an upper edge of the movable vertical plate and located above and spaced from the movable horizontal plate; the movable connection plate having a hollow connection cylinder for extending through the fixed connection hole on the fixed suspension plate, and the hollow connection cylinder internally defining a movable connection bore, which axially extends through the hollow connection cylinder and is located above the fixed hole.

7. The beverage maker with helically dispensed brewing water as claimed in claim 6, wherein the movable vertical plate is extended through the fixed hole, such that the movable horizontal plate and the movable connection plate are located at a lower and an upper side of the fixed hole, respectively, and both of the movable horizontal plate and the movable connection plate are axially located outside the fixed hole.

8. A beverage maker with helically dispensed brewing water, comprising:
a fixed support;
a rotating mechanism including a movable support movably connected to the fixed support and a driving source connected to the fixed support; the movable support being provided with an elongated guide slot; and the driving source being capable of driving the movable support to rotate about a rotation axis;
a reciprocating mechanism being provided on the movable support to rotate synchronously with the movable support; the reciprocating mechanism including:
a shifting member being provided with a first gear rack and a second gear rack spaced from each other; and
a rotation gear being rotatably connected to the movable support and including a half gear section located between the first and the second gear rack; the half gear section being rotatable, such that a connection relation between the shifting member and the rotation gear is switchable sequentially from a first operational state, in which the half gear section is engaged with the first gear rack, to a first idle state, in which the half gear section is disengaged from the first gear rack, and then to a second operational state, in which the half gear section is engaged with the second gear rack, and finally to a second idle state, in which the half gear section is disengaged from the second gear rack; and
wherein, when the connection relation between the shifting member and the rotation gear is switched from the second idle state to the first operational state, the half gear section is disengaged from the second gear rack, and the rotation gear in rotating brings the shifting member to move in a first direction; and
wherein, when the connection relation between the shifting member and the rotation gear is switched from the first idle state to the second operational state, the half gear section is disengaged from the first gear rack, and the rotation gear in rotating brings the shifting member to move in a second direction that is opposite to the first direction; and
a water dispensing pipe being connected to the shifting member, such that the movable support in rotating brings the water dispensing pipe to revolve about the rotation axis at the same time; meanwhile, the water dispensing pipe being brought by the shifting member to move in one of the first direction and the second direction.
